(19) United States
(12) Patent Application Publication
(10) Pub. No.: US 2016/0131050 A1
(43) Pub. Date: May 12, 2016

(54) METHOD FOR CONTROLLING AN ELECTRICAL COMPRESSOR FOR SUPERCHARGING AN INTERNAL COMBUSTION ENGINE

(71) Applicant: VALEO SYSTEMES DE CONTROLE MOTEUR, Cergy Saint Christophe (FR)

(72) Inventors: Yiming Wu, Colombes (FR); Sylvain Decoster, Fontenay Le Fleury (FR)

(73) Assignee: VALEO SYSTEMES DE CONTROLE MOTEUR, Cergy Saint Christophe (FR)

(21) Appl. No.: 14/784,864

(22) PCT Filed: Apr. 15, 2014
(86) PCT No.: PCT/FR2014/050918

§ 371 Date: Jan. 21, 2016

(30) Foreign Application Priority Data
Apr. 17, 2013 (FR) 1353494

(51) Int. Cl. F02D 23/00; F02B 39/10

(52) U.S. Cl. CPC F02D 23/00; F02B 39/10

(57) ABSTRACT

A method for controlling an electrical compressor (11) forming part of an assembly comprising an internal combustion engine and an electric machine (15), the compressor (11) being configured to compress the intake air of the internal combustion engine, the electrical compressor being capable of being powered with electricity by:—first electrical energy provided by an electrical energy storage unit (10), and—second electrical energy coming from the electric machine (15) when it is driven in rotation, said method involving:—imposing a setpoint value on at least one electrical or mechanical variable of the assembly, and—at least temporarily supplying the electrical compressor (11) with the first and second electrical energy in such a way that the value of said variable approaches the setpoint value.

This invention relates to controlling an electrical compressor for supercharging an internal combustion engine of a vehicle in particular.

This compressor supports for example the turbocharger of the vehicle in certain cases, in particular at low speed and during transient increases in load, and its use aims to remedy the long response time of the turbocharger, the so-called “turbolag.”

Alternatively, the electrical compressor can temporarily replace, and not support, the turbocharger. The vehicle can even dispense with a turbocharger thanks to the presence of the electrical compressor.

Such an electrical compressor is relatively energy-intensive and its use in a vehicle requires recourse to special batteries and/or strategies for controlling the electrical compressor when the electrical energy available to supply it is insufficient. In this regard, patent EP 1 376 812 teaches reducing the drain on the electrical supercharging compressor when the source of electrical energy supplying the latter is insufficiently charged. Such a solution is not totally satisfactory because it limits the possibilities of using the electrical compressor and its support for supercharging.

In order to overcome this problem, it is feasible to provide a battery that has a larger capacity but this involves considerable cost and requires greater space.

There is a need to be able to increase the possibilities for using an electrical compressor to supercharge an internal combustion engine.

The aim of this invention is to meet that need.

This is achieved, according to one of its aspects, by adopting a method for controlling an electrical compressor forming part of an assembly that also comprises an internal combustion engine and an electric machine, the electrical compressor being configured to compress the air at the intake of the internal combustion engine and capable of being electrically supplied by:

a first electrical energy provided by an electrical energy storage unit, and

a second electrical energy coming from the electric machine when it is driven in rotation,

method whereby:

a setpoint value is imposed on at least one electrical or mechanical quantity of the assembly, and

the electrical compressor is supplied at least temporarily by the first and the second electrical energy so that the value of the said quantity approaches, and in particular reaches, the setpoint value.

According to the above method, when taking into account the imposed setpoint value, there is at least one phase during which an additional electrical energy is used in addition to that formed by the electrical energy storage unit used according to the prior art as the sole means of supplying the electrical compressor.

This additional source of electrical energy can be the electric machine directly operating as a generator or a battery or any other storer of energy charged by the electric machine when the latter operates as a generator.

The direct or indirect use of electrical energy provided by the electric machine operating as a generator enables:

the use of an electrical energy storage unit of smaller capacity and therefore of a reduced cost and size,

less drain on this electrical energy storage unit, thus to prolonging its useful life, and

a remedy in the event that the electrical energy storage unit is not sufficiently charged, without the need, for example, to reduce the drain on the electrical compressor, as taught by the above-mentioned patent EP 1 376 812.

The above method therefore widens the possibilities of use of the electrical compressor and guarantees an optimal possible drain on the latter when it is used.

The electric machine can be a rotating electric machine, for example a synchronous, asynchronous, direct-current or variable-reluctance machine. This machine can comprise a rotor capable of being driven by the shaft of the internal combustion engine, if necessary by a belt. A permanent or non-permanent connection can thus exist between the rotor of the electric machine and the shaft of the internal combustion engine.

The relationship between the first electrical energy and the second electrical energy can vary when they supply the electrical compressor simultaneously. Thus, in order to respond to the setpoint value applied for the electrical or mechanical quantity, at the time of this response the proportion of electrical energy coming directly or indirectly from the generator can be varied in relation to the electrical energy coming from the electrical energy storage unit.

The ratio between the first electrical energy and the second electrical energy decreases for example when the speed of the internal combustion engine increases.

Alternatively, the ratio between the first electrical energy and the second electrical energy decreases when the torque provided by the internal combustion engine increases.

Alternatively, the ratio between the first electrical energy and the second electrical energy can be constant when the electrical compressor is electrically powered both by the first electrical energy and by the second electrical energy in order to respond to the setpoint value imposed for the electrical or mechanical quantity of the assembly. The constant value of this ratio can be determined by the setpoint value imposed for the electrical or mechanical quantity of the assembly. In the case of a vehicle, this setpoint value is determined, for example, by the Engine Control Unit (ECU).

In light of the above, the electrical or mechanical quantity for which a setpoint value is imposed can be one from the following: the speed of rotation of the electrical compressor, the torque provided by the electrical compressor, the speed of the internal combustion engine measured at the crankshaft, the electrical energy supplying the electrical compressor, the torque provided by the internal combustion engine, and the pressure at the intake of the internal combustion engine, this pressure being measured in particular in the intake manifold of the internal combustion engine.

In light of the above, the ratio between the first electrical energy and the second electrical energy can assume several discrete values of which at least one is greater than ten and of which at least one other is less than a quarter. It is therefore more or less possible to use the second electrical energy, i.e. that coming from the generator, in order to conserve the first electrical energy.

Before electrically supplying the electrical compressor with the first and second electrical energy, at least one electrical or mechanical quantity of the assembly can be compared with a threshold value, which is a percentage of the setpoint value for this electrical or mechanical quantity. The comparison aims for example to determine whether the internal combustion engine is running at transient speed. When it emerges from this comparison that this is the case, the electrical compressor can remain supplied only by the first electrical energy. In fact, a use at this stage of the electric machine running as a generator as a source of electrical energy could generate additional friction on the crankshaft of the internal combustion engine, which would have undesirable consequences. Furthermore, at transient speed, the response time of the electric machine running as a generator necessary for the latter to provide the second electrical energy can be relatively long, so that monitoring by the internal combustion engine of the setpoint value is therefore unsatisfactory.

The speed of the electrical compressor is compared for example with a percentage of the setpoint value, imposed in particular by the ECU, for this speed of the electrical compressor. Alternatively, the pressure in the intake manifold of the internal combustion engine is compared with a percentage of the setpoint value, imposed in particular by the ECU, for this pressure in the intake manifold of the internal combustion engine.

Before electrically supplying the electrical compressor with the first and second electrical energy, at least one electrical or mechanical quantity of the assembly can be compared with a threshold value which is a percentage of the nominal value for said electrical or mechanical quantity. The comparison aims for example to determine whether the electrical compressor is running at a very high power. When it emerges from this comparison that this is the case, the electrical compressor can remain supplied only by the first source of electrical energy. In fact, supplying the electrical compressor with the second electrical energy would lead to drawing off a high torque on the electric machine running as a generator, which is undesirable. The electric power supplying the electrical compressor is compared for example with a percentage of its nominal power.

According to a particular embodiment of the invention, the method can comprise the following stages:

the value of a first electrical or mechanical quantity of the assembly is compared with a first threshold value, which is a percentage of the setpoint value for the said first electrical or mechanical quantity,

the value of a second electrical or mechanical quantity of the assembly is compared with a second threshold value which is a percentage of the nominal value for the said second electrical or mechanical quantity, and

the value of a third electrical or mechanical quantity of the assembly is compared with a third threshold value which is a percentage of the setpoint value for the said third electrical or mechanical quantity.

According to this particular embodiment of the invention, the electric supply of the electrical compressor with the first and the second electrical energy can therefore only be provided:

when the said first quantity has a value greater than the first threshold value,

when the said second quantity has a value lower than the second threshold value, and

when the said third quantity has a value greater than the said third threshold value.

It may therefore be necessary to check several cumulative conditions before switching from one supply of the electrical compressor solely by the first electrical energy to a supply of the electrical compressor by the first electrical energy and by the second electrical energy. According to this particular embodiment of the invention, the first electrical or mechanical quantity of the assembly can be the speed of rotation of the electrical compressor, the second electrical or mechanical quantity of the assembly can be the electrical energy of the electrical compressor, and the third electrical or mechanical quantity of the assembly can be the pressure measured at the intake of the internal combustion engine.

The electrical compressor and the electric machine can be controlled as follows:

the value of at least one operating parameter of the assembly is measured,

the measured value of the operating parameter of the assembly is compared with a predetermined setpoint value for this operating parameter and a value for at least one control parameter of the electrical compressor is generated on the basis of the result of this comparison.

the measured value of the operating parameter of the assembly is compared with a percentage of the predetermined setpoint value for the said operating parameter of the assembly and, on the basis of the result of this comparison, a value is generated for at least one control parameter of the electric machine.

Each generation based on the result of a comparison can trigger the intervention of a corrector, for example a PID corrector. Thus, the control of the electrical compressor and the electric machine can trigger the intervention of a double control loop. A same operating parameter of the assembly can be measured and the value measured for this parameter can be compared a first time with a setpoint value to generate a control parameter of the electrical compressor and a second time with a value being a percentage of the setpoint value to generate a control parameter of the electric machine.

This double regulation can thus enable a progressive activation of the electric machine operating as a generator, meaning that the latter progressively supplies electrical energy. Double regulation can also enable a dynamic control of the supply of the electrical compressor.

The operating parameter of the assembly is for example chosen from: the pressure measured at the intake of the internal combustion engine, particularly the pressure measured in the intake manifold of the internal combustion engine, the torque provided by this internal combustion engine, the flow of air entering this internal combustion engine and the speed of rotation of this internal combustion engine, measured in particular on the crankshaft.

The predetermined setpoint value for the said operating parameter of the assembly comes for example from the ECU.

The control parameter of the electrical compressor is for example the speed of rotation of the electrical compressor whereas the control parameter of the electric machine is a regulation voltage or a supply current of the electric machine, in particular of the electric winding of the stator or the electric winding of the rotor of this electric machine.

As can be seen, a different regulation can be implemented for the electrical compressor and for the electric machine. Thus, if the control parameter of the electrical compressor is regulated by using the predetermined setpoint value for the operating parameter of the assembly, the control parameter of the electric machine is regulated by using a percentage of this predetermined setpoint value. The percentage is for example greater than 80%, being in particular 80%, 90% or 95%. Thus, the electric machine can be controlled so that the second electrical energy supplied to the electrical compressor represents in relation to the total amount of electrical energy consumed by the electrical compressor a value equal to the said percentage. In other words, only a fraction of the electrical energy consumed by the electrical compressor can therefore correspond to the first electrical energy coming from the electrical energy storage unit. In certain cases, only 5 to 20% of the electrical energy consumed by the electrical compressor can thus come from this electrical energy storage unit, enabling the latter to have less draw upon it and be of an accordingly smaller size.

If necessary, the third threshold value can correspond to a percentage of the setpoint value for the third electrical or mechanical quantity of the assembly, which may or may not be equal to the percentage used for the regulation of the control parameter of the electrical compressor.

In light of the above, prior to the supply by the first and by the second electrical energy of the electrical compressor, the latter can beforehand be supplied exclusively by the first electrical energy.

Alternatively, in light of the above, prior to the supply by the first and by the second electrical energy of the electrical compressor, the latter can beforehand be supplied exclusively by the second electrical energy.

In light of the above, after the supply by the first and the second electrical energy of the electrical compressor, the latter can be exclusively supplied by the second electrical energy.

In light of the above, the storage unit of electrical energy supplying the first electrical energy can be a battery or one or more batteries assembled in series or in parallel. Alternatively, one or more super-condensers can be used. The storage unit of electrical energy has for example a nominal voltage of between 12 V and 48 V, for example between 12 V and 30 V, for example from 12 V to 16 V.

Another aim of the invention, according to another of its aspects, is an electrical network enabling the above-mentioned method to be implemented. The network can be configured to allow one of the following modes of electrical supply of the electrical compressor:

electrical supply exclusively by the first electrical energy,

electric supply both by the first electrical energy and by the second electrical energy.

If necessary, the electrical network can be configured to allow the electrical supply of the electrical compressor to be exclusively by the second electrical energy.

The electrical network is for example the vehicle's on-board network.

A better understanding of the invention will emerge from the following description of a non-limiting embodiment thereof and from the examination of the accompanying drawings in which:

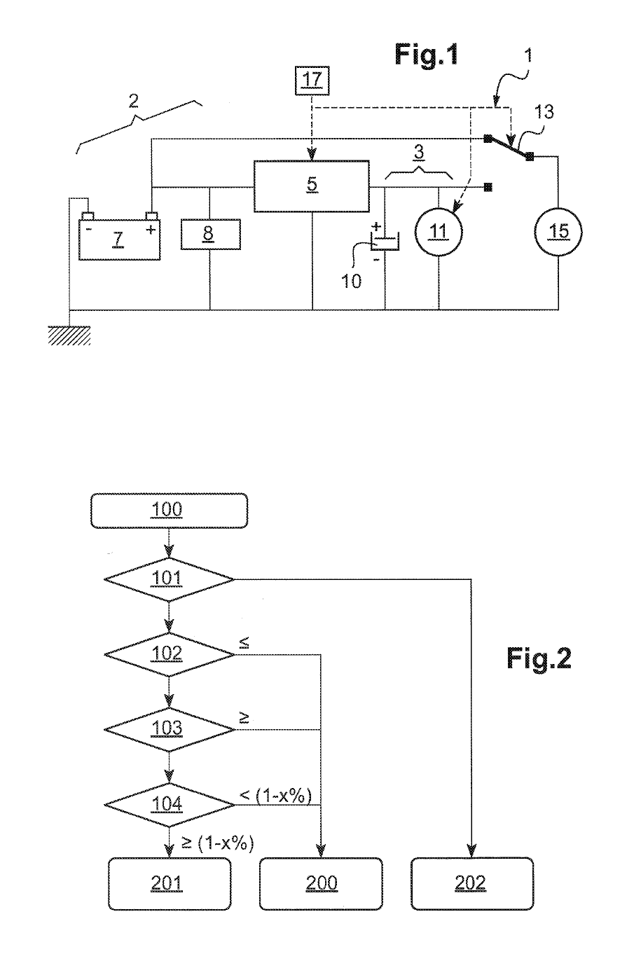

FIG. 1 is a schematic representation of an example of an electrical network within which the method according to the invention can be implemented,

FIG. 2 is a diagram representing different stages performed with a view to electrically supplying the electrical compressor according to an embodiment of the method according to the invention,

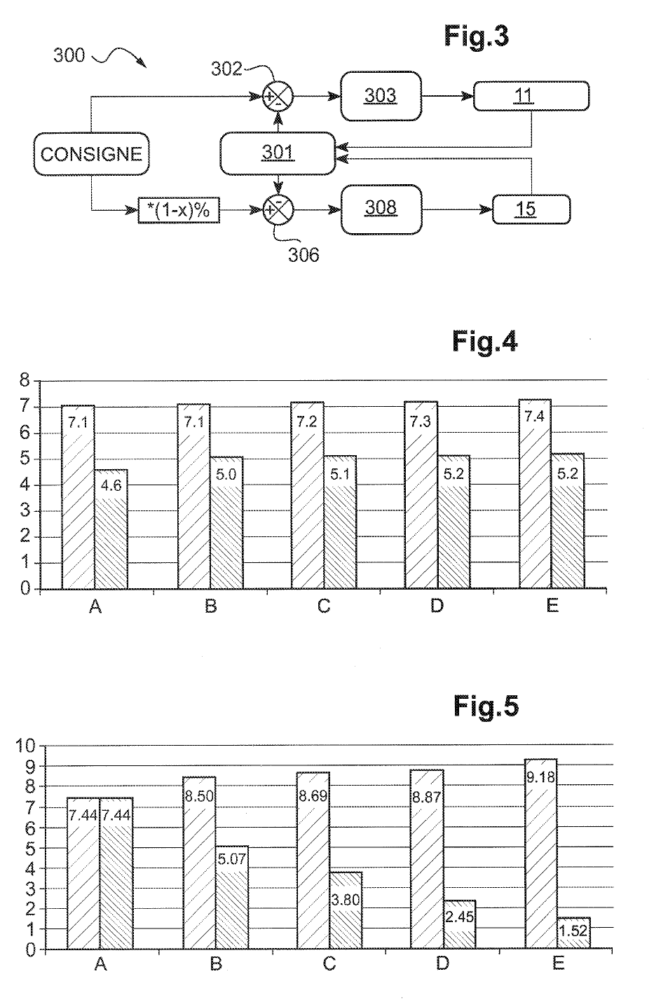

FIG. 3 represents in the form of a block diagram an example of regulation enabling the implementation of the method according to the invention, and

FIGS. 4 and 5 are diagrams highlighting in particular the contribution of the invention compared to the prior art.

FIG. 1 represents an electrical network 1 used to supply electrically an electrical compressor 11 to supercharge an internal combustion engine. The internal combustion engine is in this embodiment deemed used for a power plant of a vehicle. The electrical network 1 can therefore be the on-board network of the vehicle.

The internal combustion engine and the electrical compressor 11 form part of an assembly that also includes and electric machine 15, as will be described later.

The electrical compressor 11 is configured to inject air under pressure into the intake line of the internal combustion engine, this electrical compressor 11 supporting or replacing the turbocharger of the vehicle particularly at low speed and during transient increases in load.

The network 1 comprises a first circuit 2 and a second circuit 3. In the example in FIG. 1, the first 2 and second 3 circuit are connected together by a connecting element 5, which allows a selective communication between the first circuit 2 and the second circuit 3. The connecting element 5 is for example a DC-to-DC voltage converter that can operate in step-up or step-down mode, as required. Alternatively, the connecting element 5 can be formed by a simple switch, for example a mechanical switch such as a pushbutton, an electro-mechanical switch such as a relay, or even an electronic switch such as a transistor. As another alternative, the connecting element 5 is a linear-operation switch when it closes, or a variable-value resistor, this value being able to vary in particular between two extreme values whose ratio may be ten, or even twenty, or even forty or even a hundred.

The first circuit 2 comprises in the example described a first power source 7 supplying some first electronic components 8. In the example shown, the first electronic components 8 are mounted in parallel at the terminals of the first source 7. The electronic components 8 are for example comfort and/or safety components of the vehicle.

The second circuit 3 comprises a second supply source 10, henceforth called the “electrical energy storage unit,” to the terminals of which is connected the electrical supercharging compressor 11. The electrical energy storage unit 10 can thus supply a first electrical energy to the electrical compressor so as to drive the latter in rotation. In the example considered, the electrical energy storage unit 10 is a super-capacitor. The first source 7 supplies for example a continuous voltage of 12 V whereas the electrical energy storage unit supplies a continuous voltage of between 12 V and 30 V, for example from 12 V to 16 V.

Network 1 also comprises an electric machine 15 capable of operating as a generator. It is for example a permanent-magnet synchronous machine.

This electric machine 15 is here capable of being connected selectively to the first circuit 2 or to the second circuit 3 by means of a switch 13. In the example considered, when the switch 13 connects the electric machine 15 to the terminals of the electrical compressor 11, the electric machine 15 is mounted in parallel with the electrical energy storage unit 10 so that the electrical compressor 11 can be simultaneously electrically supplied by the first electrical energy provided by the electrical energy storage unit 10 and by the second electrical energy coming from the electric machine 15 operating as a generator.

The network 1 can also comprise a starter, not shown, which is for example mounted in parallel with the electric machine 15.

The network 1 also comprises a control unit 17, configured to act on the configuration of the connecting element 5, of the switch 13, and to activate or not activate the electrical compressor 11. The control unit 17 may or may not be centralized and for example implement one or more microcontrollers. The operation of this control unit 17 will be described later. This control unit 17 can be distinct from the engine control unit (ECU). Alternatively, the control unit 17 is integral with the engine control unit.

The control unit 17 can determine that the electrical compressor 11 must be activated. This is notably the case in the example illustrated at low speed or in the event of a transient increase in load.

With reference to FIG. 2, an example of control by the control unit 17 of the electrical supply of the electrical compressor 11 will now be described. Stage 100 corresponds to the order to activate the electrical compressor 11 to respond to a set point, on the engine speed for example.

Stage 101 corresponds to a check performed by the control unit 17 of the state of charge of the electrical energy storage unit 10. If this state of charge is below a threshold value, for example a low percentage such as 50% of the nominal capacity of the electrical energy storage unit 10 if the latter is a “lead” battery, the electrical compressor passes into state 202 in which the electrical supply of the electrical compressor 11 to drive the latter in rotation is exclusively provided by the second electrical energy supplied by the electric machine 15 operating as a generator. Switch 13 is then operated so that it electrically connects the electric machine 15 and the electrical compressor 11.

When the state of charge of the electrical energy storage unit 10 is sufficient, the electrical compressor passes into state 200 in which it is electrically supplied exclusively by the first electrical energy provided by said unit 10. This state 200 prevails until it is detected during stage 102 by the control unit 17 that the value of the speed of rotation of the electrical compressor 11 exceeds a first threshold value. This first threshold value is for example equal to a percentage of a set point value, established in particular by the vehicle's engine control unit.

It is determined for example whether the speed of rotation of the electrical compressor 11 is greater than 80% of the setpoint value. If it is not, the electrical compressor remains in state 200. If it is, it is calculated that the internal combustion engine is no longer in transient mode and the control unit 17 proceeds during stage 103 to make a comparison between the value of the electrical energy of the electrical compressor 11 and a second threshold value. This second threshold value is in the example in question a percentage of the nominal power of the electrical compressor 11. It is then determined for example whether the power of the electrical compressor 11 is below 90% of the nominal power of this compressor 11. If it is, the electrical compressor 11 remains in state 200.

If it is not, it is considered that the electrical compressor 11 is not saturated with electrical power and the control unit 17 proceeds in stage 104 to make a comparison between the value of the pressure in the intake manifold of the internal combustion engine and a third threshold value. This third threshold value is for example equal to a percentage of a setpoint value, established in particular by the ECU. During this stage, it is determined for example whether the pressure measured in the intake manifold of the internal combustion engine is above 90% of the setpoint value established by the ECU.

If it is, it is estimated that the pressure at the engine intake is sufficiently close to the setpoint value for the electric machine 15 to be drawn upon to provide the second electrical energy without this causing too long a response time and/or without this leading to too great a draw-off of torque from said machine. The electrical compressor 11 then passes into state 201 in which it is electrically supplied both by the first electrical energy provided by the electrical energy storage unit 10 and by the second electrical energy coming from the electric machine 15 operating as a generator. If it is not, the electrical compressor 11 remains in state 200.

There now follows a description with reference to FIG. 3 of an example of controlling the electrical compressor 11 and the electric machine 15 operating as a generator, if the electrical compressor is in state 201.

This control implements a double regulation loop 300. A sensor 301 measures an operating parameter of the internal combustion engine, such as the pressure in the intake manifold of an internal combustion engine or the torque provided by this internal combustion engine.

A first comparison 302 is made between the value provided by this sensor and a setpoint value imposed for this parameter, in this example for the pressure in the intake manifold of the internal combustion engine or the torque provided by this engine. The setpoint value is for example established by the ECU. The result of this comparison triggers a corrector 303, which in the example in FIG. 3 is a PID corrector. This corrector 303 thus generates a setpoint value of a control parameter of the electrical compressor 11, for example a setpoint value of the speed of the electrical compressor 11.

A second comparison 306 is made between the value provided by the sensor and a percentage of the setpoint value imposed for this parameter. The percentage is for example equal to that taken into account at stage 104. In the present case, the value provided by the sensor is compared in 306 with 90% of the setpoint value imposed, for example, by the ECU for the pressure in the intake manifold of the internal combustion engine or the torque provided by this internal combustion engine. The result of this comparison triggers a corrector 308, which in the example of FIG. 3 is also a PID corrector. This corrector 308 thus generates a setpoint value of a control parameter of the electric machine 15, for example of the supply voltage of the stator of the electric machine 15.

In the present case, the power of the electrical compressor 11 is regulated with the aid of a given setpoint whereas the power of the electric machine 15 is regulated with the aid of another setpoint whose value is equal to a percentage of the setpoint value used to regulate the power of the electric compressor 11. The difference in power due to the difference between these two setpoint values can correspond to the power to be contributed by the electrical energy storage unit 10 when the electrical compressor is in state 201.

FIGS. 4 and 5 show different results obtained when passing from 30 km/h to 70 km/h in 3rd gear with a 1.2 L cubic capacity internal combustion engine.

FIG. 4 shows different “vehicle acceleration time (in grey)/activation time of the electrical compressor 11 (in black)” pairings depending on the amplitude of the electrical supply of the electrical compressor 11 by the second electrical energy. These times are expressed in seconds.

FIG. 5 shows different “energy consumption by the electrical compressor 11 (in grey)/consumption of the first electrical energy by the electrical compressor 11 (in black)” pairings, in other words different “total energy consumed by the electrical compressor 11 during this acceleration (in grey)/energy provided exclusively by the electrical energy storage unit 10 (in black)” pairings. These energies are expressed in kJ.

In A, only the first electrical energy is used to supply the electrical compressor 11, which corresponds to the prior art.

In B, the electrical compressor passes into state 201 when the pressure in the intake manifold of the internal combustion engine exceeds 95% of the setpoint value, meaning that stage 104 is performed by comparison between the value measured for this pressure and a value equal to 95% of the third setpoint value.

When the electrical compressor 11 is then in state 201, the power of the electric machine 15 is then regulated around a setpoint value equal to 95% of the setpoint value used to regulate the power of the electrical compressor 11.

In C the electrical compressor passes into state 201 when the pressure in the intake manifold of the internal combustion engine exceeds 90% of the setpoint value, meaning that stage 104 is performed by comparison between the value measured for this pressure and a value equal to 90% of the third setpoint value.

When the electrical compressor 11 is then in state 201, the power of the electric machine 15 is then regulated around a setpoint value equal to 90% of the setpoint value used to regulate the power of the electrical compressor 11.

In D, the electrical compressor passes into state 201 when the pressure in the intake manifold of the internal combustion engine exceeds 85% of the setpoint value, meaning that stage 104 is performed by comparison between the value measured for this pressure and a value equal to 85% of the third setpoint value.

When the electrical compressor 11 is then in state 201, the power of the electric machine 15 is then regulated around a setpoint value equal to 85% of the setpoint value used to regulate the power of the electrical compressor 11.

In E, the electrical compressor passes into state 201 when the pressure in the intake manifold of the internal combustion engine exceeds 80% of the setpoint value, meaning that stage 104 is performed by comparison between the value measured for this pressure and a value equal to 80% of the third setpoint value.

When the electrical compressor 11 is then in state 201, the power of the electric machine 15 is then regulated around a setpoint value equal to 80% of the setpoint value used to regulate the power of the electrical compressor 11.

This shows that the fact of drawing upon the electric machine 15 operating as a generator to supply also the electrical compressor 11 has only slight consequences on the total duration necessary to pass from 30 km/h to 70 km/h, although the activation time of the electrical compressor 11 increases on passing from A towards E.

Note too that this slight degradation in performance of the internal combustion engine is accompanied by a substantial gain as regards the consumption of first electrical energy provided by the electrical energy storage unit 10 by the electrical compressor 11. In fact, from a regulation percentage of 95% for the electric machine 15 operating as a generator, the proportion of the first electrical energy in the electrical energy consumed by the electrical compressor 11 is significantly reduced.

It will be noted for example for a regulation percentage of 80% that the share of first electrical energy supplied by the electrical energy storage unit 10 has been considerably reduced. The size of said unit can therefore be reduced.

The invention is not limited to what has been described above.

In particular, although in this example the electric machine 15 is used directly as a source of electrical energy, in a variation, this machine 15 can inject current into an intermediate storage unit and it is the latter that supplies the electrical compressor with second electrical energy.

The expression “comprising a” must be understood to be synonymous with the expression “comprising at least one,” unless stated otherwise.

1. A method for controlling an electrical compressor forming part of an assembly that also comprises an internal combustion engine and an electric machine, the electrical compressor being configured to compress the air at the intake of the internal combustion engine and capable of being electrically supplied by:
a first electrical energy provided by an electrical energy storage unit, and
a second electrical energy coming from the electric machine when the machine is driven in rotation, the method comprising
imposing a setpoint value on at least one electrical or mechanical quantity of the assembly; and
supplying the electrical compressor at least temporarily by the first and the second electrical energy so that the value of the said quantity approaches the setpoint value.

2. The method according to claim 1, wherein the ratio between the first electrical energy and the second electrical energy varies when the latter simultaneously supply the electrical compressor.

3. The method according to claim 2, wherein the ratio between the first electrical energy and the second electrical energy decreases when the speed of the internal combustion engine increases.

4. The method according to claim 2, wherein the ratio between the first electrical energy and the second electrical energy decreases when the torque provided by the internal combustion engine increases.

5. The method according to claim 1, wherein the ratio between the first electrical energy and the second electrical energy assumes several discrete values of which at least one is greater than ten and of which at least one other is less than a quarter.

6. The method according to claim 1, wherein before electrically supplying the electrical compressor with the first and second electrical energy, at least one electrical or mechanical quantity of the assembly is compared with a threshold value, which is a percentage of the setpoint value for this electrical or mechanical quantity.

7. The method according to claim 6, wherein before electrically supplying the electrical compressor with the first and second electrical energy, at least one electrical or mechanical quantity of the assembly is compared with a threshold value which is a percentage of the nominal value for said electrical or mechanical quantity.

8. The method according to claim 6, wherein:
the value of a first electrical or mechanical quantity of the assembly is compared with a first threshold value, which is a percentage of the setpoint value for the said first electrical or mechanical quantity,
the value of a second electrical or mechanical quantity of the assembly is compared with a second threshold value which is a percentage of the nominal value for the said second electrical or mechanical quantity, and
the value of a third electrical or mechanical quantity of the assembly is compared with a third threshold value which is a percentage of the setpoint value for the said third electrical or mechanical quantity.

9. The method according to claim 8, wherein the electrical compressor is electrically supplied with the first and second electrical energy when the said first quantity has a value greater than the first threshold value, when the said second quantity has a value less than the second threshold value, and when the said third quantity has a value greater than the said third threshold value.

10. The method according to claim 8, wherein the first electrical or mechanical quantity of the assembly is the speed of rotation of the electrical compressor, the second electrical or mechanical quantity of the assembly is the electrical energy of the electrical compressor, and wherein the third electrical or mechanical quantity of the assembly is the pressure measured at the intake of the internal combustion engine.

11. The method according to claim 1, wherein, in order to control the electrical compressor and the electric machine:
the value of at least one operating parameter of the assembly is measured,
the measured value of the operating parameter of the assembly is compared with a predetermined setpoint value for this operating parameter and a value for at least one control parameter of the electrical compressor is generated on the basis of the result of this comparison.
the measured value of the operating parameter of the assembly is compared with a percentage of the predetermined setpoint value for the said operating parameter of the assembly and, on the basis of the result of this comparison, a value is generated for at least one control parameter of the electric machine.

12. The method according to claim 11, wherein the operating parameter of the assembly is chosen from: the pressure measured at the intake of the internal combustion engine, to torque provided by this internal combustion engine and the airflow at the intake of the internal combustion engine.

13. The method according to claim 12, wherein the control parameter of the electrical compressor is the speed of rotation of the electrical compressor and wherein the control parameter of the electric machine is a regulation voltage of the electric machine.

14. The method according to claim 1, comprising a prior stage during which the electrical compressor is supplied exclusively by the first electrical energy.

15. The method according to claim 1, comprising a prior stage during which the electrical compressor is supplied exclusively by the second electrical energy.
